(19) United States
(12) Patent Application Publication
(10) Pub. No.: US 2003/0159710 A1
(43) Pub. Date: Aug. 28, 2003

(54) Cleaning apparatus and method

(75) Inventors: Koji Teranishi, Kanagawa (JP); Yasuyuki Suzuki, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/368,624

(22) Filed: Feb. 20, 2003

(30) Foreign Application Priority Data
Feb. 25, 2002 (JP) 2002-048035

(51) Int. Cl. B08B 3/12

(52) U.S. Cl. 134/1; 134/21; 134/37; 134/95.1; 134/102.2

(57) ABSTRACT

There is provided a cleaning apparatus having a first vacuum container into which a cleaning object is to be introduced, a second vacuum container set apart from the first vacuum container by means of a light-transmissive member, a pump for evacuating the inside of each of the first vacuum container and the second vacuum container, a gas feed means for feeding an electric-discharge gas into the second vacuum container, and an electric-discharge generation means for generating electric discharge in the second vacuum container, wherein the cleaning object is irradiated through the light-transmissive member by light produced by the electric discharge generated in the second vacuum container.

### BACKGROUND OF THE INVENTION

1. Field of the Invention

This invention relates to a cleaning apparatus and a cleaning method making use of the cleaning apparatus. The cleaning apparatus and cleaning method of the present invention are especially suited for the cleaning of optical elements used in semiconductor exposure devices and so forth.

2. Related Background Art

In recent years, a semiconductor exposure device called a stepper is used in techniques of exposing or transferring micropatterns of integrated circuits. Light sources for such exposure are being made into shorter-wavelength types such as an ArF excimer laser (193 nm) and further an F₂ excimer laser (157 nm) as large-scale integrated circuits (LSIs) have come more highly integrated.

As materials for optical elements used in such steppers, it is proposed to use fluorite (CaF₂) as having better transmittance. Lenses mounted in such steppers are in a large number. Even if each lens has a small transmittance loss, the combination of a large number of lenses causes a great transmittance loss to make the quantity of light insufficient at irradiated surfaces. Accordingly, not only optical thin films but also making optical materials have low transmittance loss are essential subjects.

Meanwhile, the transmittance of materials (base materials) of such optical elements varies sensitively, depending on the state of surfaces. Usually, in leaving such base materials of optical elements in the atmosphere, deposits which are considered to be organic components in the atmosphere become deposited gradually on the surfaces to make optical characteristics vary. In particular, the transmittance tends to vary so greatly that it may lower because of these deposits. Such a result has also been ascertained. Such a lowering of transmittance comes remarkably, especially in the ultraviolet light region. The occurrence of these variations brings about a problem that the optical instruments such as steppers can not attain their desired performance. Accordingly, various methods as stated below have been proposed as cleaning methods for optical elements.

Japanese Patent Application Laid-Open No. 9-155309 discloses a cleaning method having the step of washing an optical element with an organic solvent or an aqueous cleaning agent, the step of subsequently soaking the optical element in water to rinse the organic solvent or aqueous cleaning agent away, thereafter the step of displacing the water content by using a hydrophilic solvent and further the step of immersing the optical element in a non-hydrophilic solvent to remove the hydrophilic solvent.

However, a result has been ascertained that the optical element comprised of fluorite, having been cleaned by the above method, can not achieve any satisfactory value as its transmittance at, e.g., 193 nm, the wavelength of the ArF excimer laser, and 157 nm, the wavelength of the F₂ excimer laser, and the method is inadequate as a method of cleaning the lenses to be mounted in steppers.

Meanwhile, Japanese Patent Application Laid-Open No. 10-158035 (corresponding to U.S. Pat. No. 5,983,672 and U.S. Pat. 6,269,661) discloses a cleaning method in which, after an optical element is heated, it is irradiated by ultraviolet rays. Japanese Patent Application Laid-Open No. 11-116281 also discloses a cleaning method in which an optical element is irradiated by laser light. Japanese Patent Application Laid-Open No. 2000-343049 further discloses a method in which, after an optical element has been washed with an organic solvent, the optical element is irradiated by ultraviolet rays to clean.

In any of the above methods, however, slight residues of organic matter or a residue of the organic solvent may remain, and hence these methods have been inadequate for preventing the lowering of transmittance.

The problems as stated above have been common to the cleaning of articles sensitive to stains of surfaces, without limitation to the cleaning of optical elements.

### SUMMARY OF THE INVENTION

An object of the present invention is to solve the problems the related background art has had, to provide a cleaning apparatus, and a cleaning method, which can remove in a short time any stains having deposited on articles to be cleaned (cleaning objects) and being not removable with organic solvents.

To achieve the above object, the present invention provides a cleaning apparatus comprising:

a first vacuum container into which a cleaning object is to be introduced;

a second vacuum container set apart from the first vacuum container by means of a light-transmissive member;

a pump for evacuating the inside of each of the first vacuum container and the second vacuum container;

a gas feed means for feeding an electric-discharge gas into the second vacuum container; and

an electric-discharge generation means for generating electric discharge in the second vacuum container,

wherein the cleaning object is irradiated through the light-transmissive member by light produced by the electric discharge generated in the second vacuum container.

The present invention also provides a cleaning method making use of the above cleaning apparatus, the method comprising the steps of:

introducing a cleaning object into the first vacuum container;

generating electric discharge in the second vacuum container; and

irradiating the cleaning object through the light-transmissive member by light produced by the electric discharge generated in the second vacuum container.

The present invention still also provides a cleaning apparatus comprising:

a first vacuum container into which a cleaning object is to be introduced;

a second vacuum container set apart from the first vacuum container;

a feed pipe which connects the first and second vacuum containers via a valve;

a pump for evacuating the inside of each of the first vacuum container and the second vacuum container;

a gas feed means for feeding an electric-discharge gas into the second vacuum container; and

an electric-discharge generation means for generating electric discharge in the second vacuum container,

wherein a radical species produced by the electric discharge generated in the second vacuum container is introduced into the first vacuum container through the valve.

The present invention further provides a cleaning method making use of the above second cleaning apparatus, the method comprising the steps of:

introducing the cleaning object into the first vacuum container;

generating electric discharge in the second vacuum container; and

opening the valve to introduce the radical species produced by the electric discharge generated in the second vacuum container, into the first vacuum container through the feed pipe to clean the cleaning object with this radical species.

### BRIEF DESCRIPTION OF THE DRAWINGS

FIG. 1 is a schematic cross section showing an embodiment of the cleaning apparatus of the present invention.

FIG. 2 is a graph showing a transmission spectrum of a glass substrate in Example 1 of the present invention.

FIG. 3 is a graph showing a transmission spectrum of a glass substrate in Example 2 of the present invention.

FIG. 4 is a graph showing a transmission spectrum of a glass substrate in Example 3 of the present invention.

FIG. 5 is a graph showing a transmission spectrum of a glass substrate in Example 4 of the present invention.

### DESCRIPTION OF THE PREFERRED EMBODIMENTS

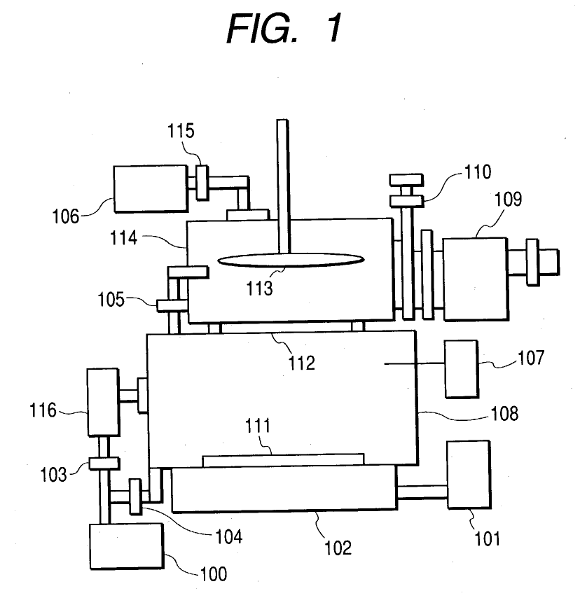

FIG. 1 is a schematic cross section showing an embodiment of the cleaning apparatus of the present invention. The cleaning apparatus shown in FIG. 1 has a first vacuum container 114 and a second vacuum container 108. These vacuum containers are set apart by means of a light-transmissive member 112 comprised of CaF₂ glass or quartz glass. To the first vacuum container 114, a dry pump 106 is connected via a valve 115. Also, to the first vacuum container 114, a cryogenic pump 109 is connected via a valve 110. A cleaning object is introduced into this first vacuum container 114. The cleaning object introduced thereinto is placed on a work support stand 113.

Meanwhile, to the second vacuum container 108, a dry pump 100 is connected via a valve 104, and a turbo pump 116 is further connected via a valve 103. Also, the apparatus is so constructed that electric-discharge gas is introduced into the second vacuum container 108 by a gas feed means 107. It is further so constructed that microwaves are applied from a microwave power source 101 through a waveguide 102 and a guide window 111. Then, the electric-discharge gas is introduced into the second vacuum container 108 and the electric discharge is generated upon application of the microwaves.

The first vacuum container 114 and the second vacuum container 108 are connected with each other through a feed pipe via a valve 105, and they are so constructed that a radical species produced in the second vacuum container 108 can be introduced into the first vacuum container 114.

According to a cleaning method of a first embodiment of the present invention, making use of the cleaning apparatus shown in FIG. 1, first, the cleaning object is introduced into the first vacuum container 114, and thereafter the inside of the first vacuum container 114 is evacuated. Meanwhile, after the inside of the second vacuum container 108 has been evacuated, the electric-discharge gas is introduced thereinto and the microwaves are applied to generate the electric discharge. Then, the cleaning object placed in the first vacuum container 114 is irradiated through the light-transmissive member 112 by the light produced by the electric discharge, to clean the surface of the cleaning object.

According to a cleaning method of a second embodiment of the present invention, making use of the cleaning apparatus shown in FIG. 1, first, the cleaning object is introduced into the first vacuum container 114, and thereafter the inside of the first vacuum container 114 is evacuated. Meanwhile, after the inside of the second vacuum container 108 has been evacuated, the electric-discharge gas is introduced thereinto and the microwaves are applied to generate the electric discharge. Then, the valve 105 is opened so that a radical species produced by the electric discharge are introduced into the first vacuum container 114 to clean the surface of the cleaning object placed in the first vacuum container 114.

Examples of the present invention are given below.

### EXAMPLE 1

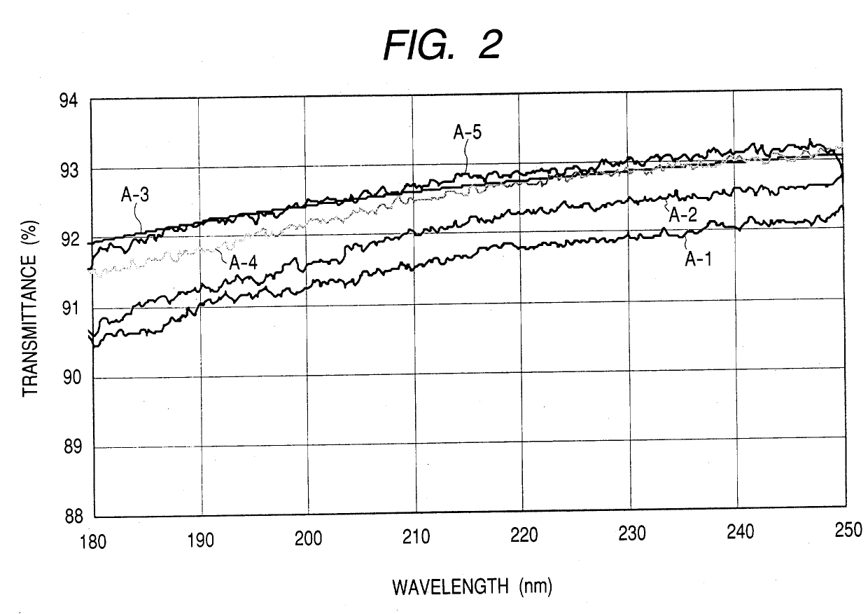

A CaF₂ glass substrate of 2 mm in thickness and 40 mm in diameter having parallel two planes having been polished was, without being cleaned, measured with a vacuum ultraviolet spectrophotometer (spectral-characteristics measuring instrument) to examine its transmittance of light having wavelength in the ultraviolet light region. The results are shown in FIG. 2 by A-1. As the result of measurement, it was found that, compared with a theoretical transmittance, a lowering of transmittance which is considered due to stains remaining on the CaF₂ substrate surface comes about in the ultraviolet light region.

Next, the surface of the CaF₂ glass substrate used in the above was washed with an organic cleaning agent composed of alcohol and ether which were mixed in a proportion of 1 to 9 in volume ratio. The CaF₂ glass substrate having been cleaned was measured with the same measuring instrument as the above to obtain the results shown in FIG. 2 by A-2. As the result of measurement, it was found that the cleaning with the organic cleaning agent brought about an improvement in transmittance in the ultraviolet light region. However, in A-2 also, a lowering of transmittance came about which was considered due to stains on the surface or residues ascribable to organic solvents, and it was found that a further improvement should be made. In FIG. 2, the transmittance of fluorite having a thickness of 2 mm that does not take account of internal absorption is shown by A-3.

Then, the same CaF₂ glass substrate as the above was washed with the same organic cleaning agent. Thereafter, this was put into the first vacuum container 114 shown in FIG. 1, and was supported with the work support stand 113. Subsequently, the dry pump 106 was actuated and the valve 115 was opened to roughing-evacuate the inside of the first vacuum container 114. Thereafter, the valve 115 was closed and the valve 110 was opened to evacuate the inside of the first vacuum container 114 to a high vacuum by means of the cryogenic pump 109, having been actuated in advance.

Meanwhile, the inside of the second vacuum container 108 was also kept evacuated in advance. To evacuate the inside of the second vacuum container 108, first the valve 104 was opened, followed by roughing-evacuation by means of the dry pump 100. Then the valve 104 was closed and the valve 103 was opened to evacuate the inside of the second vacuum container 108 to a high vacuum by means of the turbo pump 116. After the inside of the second vacuum container 108 was evacuated to a high vacuum (3×10⁻⁴ Pa), 200 cc of H₂ gas and 80 cc of Ar gas were passed into the second vacuum container 108 from the gas feed means 107. At the same time, microwaves were applied from the microwave power source 101 through the waveguide 102 and the guide window 111 to cause electric discharge to take place. Then, the CaF₂ glass substrate was irradiated through the light-transmissive member 112 for 30 minutes by the light emission species emitted by the electric discharge.

Thereafter, the inside of the first vacuum container 114 was returned to the atmospheric pressure, and the CaF₂ glass substrate was taken out to measure its transmittance with the same spectrophotometer as the above. The results are shown in FIG. 2 by A-4. As the result of measurement, it was found that, compared with the glass substrate cleaned only with the organic solvent, the irradiation by light produced by electric discharge brought about an improvement in transmittance of the CaF₂ glass substrate.

It, however, was found that the cleaning was still insufficient compared with the A-3 in FIG. 2 that did not take account of internal absorption. Accordingly, after this experiment was finished, the glass substrate having been cleaned with irradiation by light was cleaned with ultraviolet rays and ozone (UV/O₃ cleaning) by means of a UV/O₃ cleaner (manufactured by Samuko K.K.) in an atmosphere of O₂ for about 15 minutes. The transmittance of the glass substrate having been subjected to the UV/O₃ cleaning is shown in FIG. 2 by A-5. As the result, it was found that the UV/O₃ cleaning further carried out after the cleaning with light was carried out brought about a glass substrate showing a transmittance equal to the A-3 not involving any internal absorption.

### EXAMPLE 2

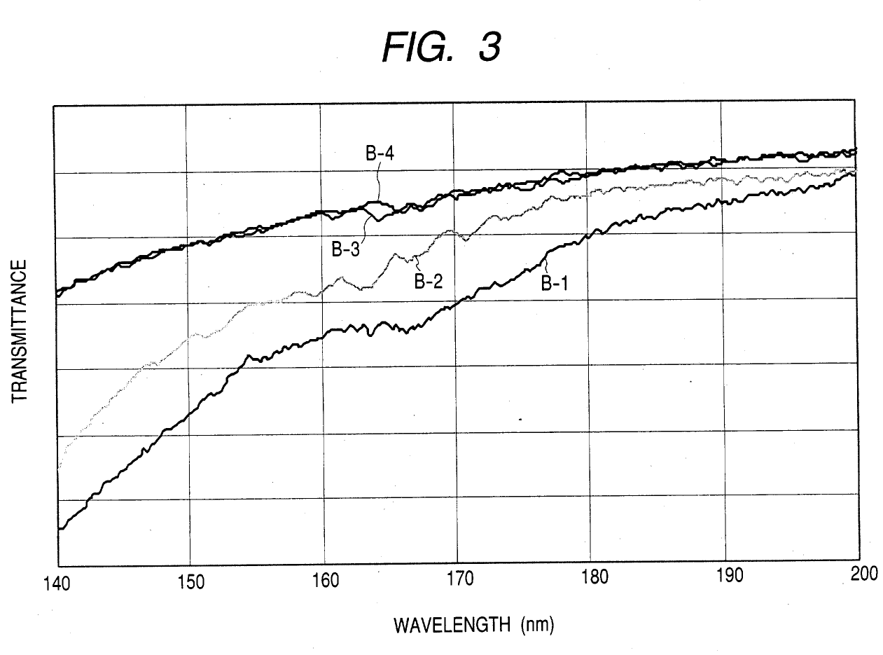

The same CaF₂ glass substrate as that in Example 1 was washed with the same organic cleaning agent as that in Example 1. Thereafter, this was measured with the vacuum ultraviolet spectrophotometer (spectral-characteristics measuring instrument) to examine its transmittance of light having wavelength in the F₂ region. The results are shown in FIG. 3 by B-1.

Then, this glass substrate was put into the first vacuum container 114 shown in FIG. 1, and the procedure of Example 1 was repeated to cause electric discharge to take place, and the glass substrate was irradiated for 30 minutes by the light emission species emitted by the electric discharge. This glass substrate was taken out to measure its transmittance with the same spectrophotometer as the above. The results are shown in FIG. 3 by B-2. As the result of measurement, it was found that, compared with the glass substrate cleaned only with the organic solvent, the irradiation by light produced by electric discharge brought about an improvement in transmittance of the CaF₂ glass substrate also in the F₂ region.

For comparison, the same CaF₂ glass substrate as the above was washed with the organic cleaning agent, and thereafter cleaned by UV/O₃ cleaning for 10 hours by means of the UV/O₃ cleaner. The transmittance of this glass substrate was measured to obtain the results shown in FIG. 3 by B-3.

Meanwhile, a sample having been cleaned by the irradiation by light was further cleaned by UV/O₃ cleaning for 1 hour. The transmittance of this sample was measured to obtain the results shown in FIG. 3 by B-4. As the result of measurement, it was found that, compared with the cleaning only with the organic solvent, the irradiation by light enabled vast improvement in transmittance and also enabled the time of UV/O₃ cleaning to be made shorter.

### EXAMPLE 3

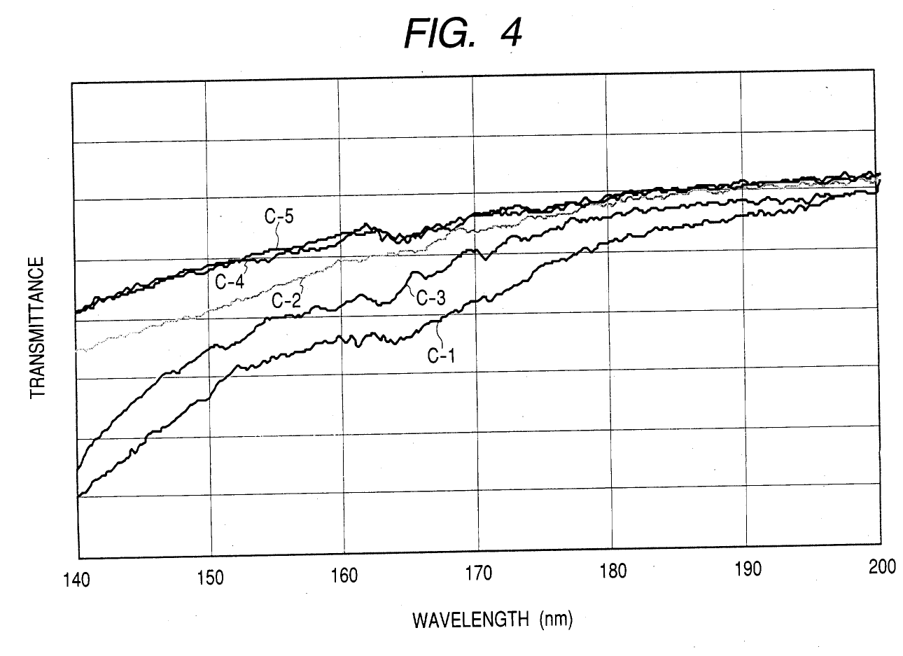

The same CaF₂ glass substrate as that in Example 1 was washed with the same organic cleaning agent as that in Example 1. Thereafter, this was measured with the vacuum ultraviolet spectrophotometer (spectral-characteristics measuring instrument) to examine its transmittance of light having wavelength in the F₂ region. The results are shown in FIG. 4 by C-1.

Next, the above glass substrate was put into the first vacuum container 114 shown in FIG. 1, and was supported with the work support stand 113. Subsequently, the dry pump 106 was actuated and the valve 115 was opened to roughing-evacuate the inside of the first vacuum container 114. Thereafter, the valve 115 was closed and the valve 110 was opened to evacuate the inside of the first vacuum container 114 to a high vacuum by means of the cryogenic pump 109, having been actuated in advance.

Meanwhile, the inside of the second vacuum container 108 was also kept evacuated in advance. To evacuate the inside of the second vacuum container 108, first the valve 104 was opened, followed by roughing-evacuation by means of the dry pump 100. Then the valve 104 was closed and the valve 103 was opened to evacuate the inside of the second vacuum container 108 to a high vacuum by means of the turbo pump 116. After the inside of the second vacuum container 108 was evacuated to a high vacuum (3×10⁻⁴ Pa), 200 cc of H₂ gas, 80 cc of Ar gas and Ar/F₂ (10%) gas were passed into the second vacuum container 108 from the gas feed means 107. At the same time, microwaves were applied from the microwave power source 101 through the waveguide 102 and the guide window 111 to cause electric discharge to take place. Then, the CaF₂ glass substrate was irradiated through the light-transmissive member 112 for 40 minutes by the light emission species emitted by the electric discharge. In that course, the valve 105 was opened and the radical species sent out by plasma were introduced into the first vacuum container 114 to carry out cleaning concurrently.

Thereafter, the inside of the first vacuum container 114 was returned to the atmospheric pressure, and the CaF₂ glass substrate was taken out to measure its transmittance with the same spectrophotometer as the above. The results are shown in FIG. 4 by C-2. As the result of measurement, it was found that, compared with the glass substrate cleaned only with the organic solvent, the cleaning with irradiation by light and with the radical species brought about an improvement in transmittance of the CaF₂ glass substrate.

Even in comparison with the results obtained after the cleaning only with the irradiation by light in Example 2 (shown in FIG. 4 by C-3), the glass substrate cleaned by the method of Example 3 is seen to be more improved in transmittance where the radical species sent out by plasma were introduced to the vicinity of the glass substrate. The glass substrate having been cleaned with the irradiation by light and the introduction of radical species was further subjected to UV/O₃ cleaning for 30 minutes. The transmittance of this glass substrate was measured to obtain the results shown in FIG. 4 by C-4. For comparison, a glass substrate having been cleaned for 10 hours by means of the UV/O₃ cleaner in Example 2 was prepared. The transmittance of this glass substrate was measured to obtain the results shown in FIG. 4 by C-5. The results of C-4 showed a value equal to C-5, and it was found that the time of cleaning can be made shorter.

### EXAMPLE 4

An optical element comprised of fluorite provided with a reflection-preventive coating was prepared as a sample. This sample was, immediately after the reflection-preventive coating was provided, left in a case made of FLUOROWARE to allow its surface to become contaminated. Then, it was ascertained whether or not this contamination was removable by the cleaning method of the present invention.

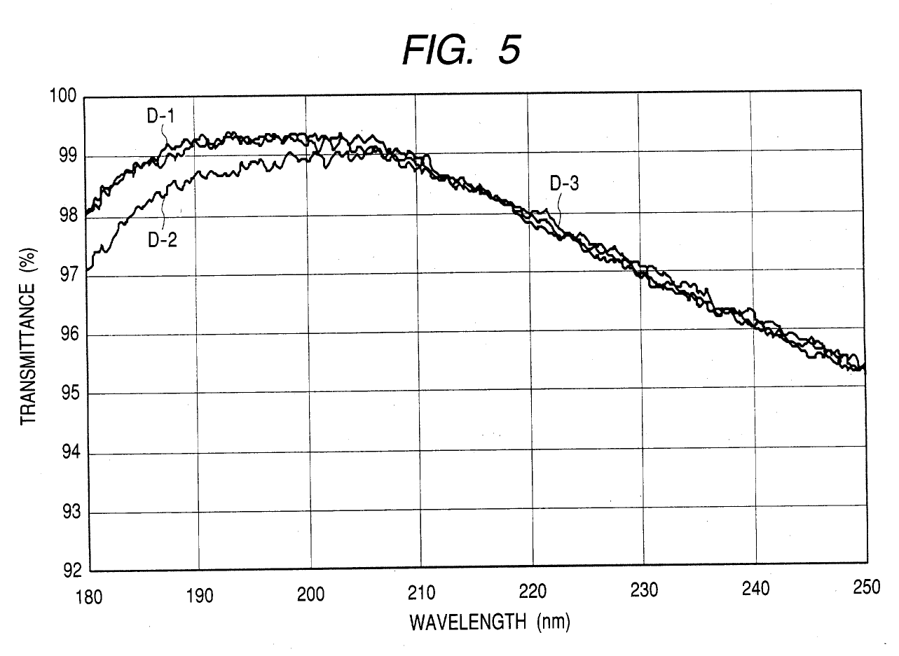

The results obtained are shown in FIG. 5. D-1 in FIG. 5 shows spectral characteristics measured immediately after reflection-preventive coating. Spectral characteristics measured after this optical element has been put in the case made of FLUOROWARE and left for 50 hours are shown in FIG. 5 by D-2. Thereafter, in the same manner as in Example 3, the sample was put into the cleaning apparatus shown in FIG. 1, and was cleaned by the irradiation by light and the introduction of radical species. The transmittance of the sample after cleaning was measured to obtain the results shown in FIG. 5 by D-3. As the result of measurement, it was ascertained that the use of the cleaning method of the present invention enabled removal also in respect of the surface contamination occurring after coating.

In the present invention, the apparatus is separately equipped for the cleaning. It, however, is considered that the same effect can be confirmed also when, e.g., a load lock chamber or the like is provided with the cleaning mechanism of the present invention. Also, the cleaning apparatus and cleaning method of the present invention is applicable to cleaning objects other than the optical elements.

What is claimed is:

1. A cleaning apparatus comprising:
a first vacuum container into which a cleaning object is to be introduced;
a second vacuum container set apart from the first vacuum container by means of a light-transmissive member;
a pump for evacuating the inside of each of the first vacuum container and the second vacuum container;
a gas feed means for feeding an electric-discharge gas into the second vacuum container; and
an electric-discharge generation means for generating electric discharge in the second vacuum container,
wherein the cleaning object is irradiated through the light-transmissive member by light produced by the electric discharge generated in the second vacuum container.

2. A cleaning method making use of the cleaning apparatus according to claim 1, the method comprising the steps of:
introducing the cleaning object into the first vacuum container;
generating electric discharge in the second vacuum container; and
irradiating the cleaning object through the light-transmissive member by light produced by the electric discharge generated in the second vacuum container.

3. The cleaning method according to claim 2, wherein, in the step of generating the electric discharge, at least one of hydrogen and fluorine is introduced into the second vacuum container.

4. The cleaning method according to claim 2, wherein, after the cleaning with irradiation by light has been carried out, the cleaning object is further irradiated by ultraviolet rays in an atmosphere of ozone to clean.

5. The cleaning method according to claim 2, which further comprises as pretreatment the step of wiping the cleaning object with an organic solvent composed chiefly of alcohol.

6. The cleaning method according to claim 2, which further comprises as pretreatment the step of etching the cleaning object with pure water.

7. The cleaning method according to claim 2, wherein the cleaning object comprises an optical element.

8. A cleaning apparatus comprising:
a first vacuum container into which a cleaning object is to be introduced;
a second vacuum container set apart from the first vacuum container;
a feed pipe which connects the first and second vacuum containers via a valve;
a pump for evacuating the inside of each of the first vacuum container and the second vacuum container;
a gas feed means for feeding an electric-discharge gas into the second vacuum container; and
an electric-discharge generation means for generating electric discharge in the second vacuum container,
wherein a radical species produced by the electric discharge generated in the second vacuum container is introduced into the first vacuum container through the valve.

9. A cleaning method making use of the cleaning apparatus according to claim 8, the method comprising the steps of:
introducing the cleaning object into the first vacuum container;
generating electric discharge in the second vacuum container; and
opening the valve to introduce the radical species produced by the electric discharge generated in the second vacuum container, into the first vacuum container through the feed pipe to clean the cleaning object with this radical species.

10. The cleaning method according to claim 9, wherein, in the step of generating the electric discharge, at least one of hydrogen and fluorine is introduced into the second vacuum container.

11. The cleaning method according to claim 9, wherein, after the cleaning with irradiation by light has been carried out, the cleaning object is further irradiated by ultraviolet rays in an atmosphere of ozone to clean.

12. The cleaning method according to claim 9, which further comprises as pretreatment the step of wiping the cleaning object with an organic solvent composed chiefly of alcohol.

13. The cleaning method according to claim 9, which further comprises as pretreatment the step of etching the cleaning object with pure water.

14. The cleaning method according to claim 9, wherein the cleaning object comprises an optical element.
